(19) United States
(12) Patent Application Publication
(10) Pub. No.: US 2006/0183093 A1
(43) Pub. Date: Aug. 17, 2006

(54) Typing-game machine and game system

(75) Inventor: Junichi Kogo, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Aruze Corp., Tokyo (JP)

(21) Appl. No.: 11/345,663

(22) Filed: Feb. 2, 2006

(30) Foreign Application Priority Data
Feb. 7, 2005 (JP) 2005-030992

(51) Int. Cl. G09B 13/00

(52) U.S. Cl. 434/227

(57) ABSTRACT

A typing-game machine has a display unit for displaying a character string, a sound output unit for outputting a sound, an input unit having keys respectively associated with characters, a judgment unit, a game control unit, and a presentation-effect limitation unit. The judgment unit judges whether a character string inputted agrees with a character string displayed or not. The presentation-effect limitation unit at least partly limits, based on a judgment result, a display made through the display unit and/or an output made through the sound output unit. The game control unit controls a game based on a first game mode in which the presentation-effect limitation unit does not work or a second game mode in which the presentation-effect limitation unit works. For a predetermined period of time after a start of a game, the game is controlled based on the first game mode irrespective of the judgment result.

### CROSS REFERENCE TO RELATED APPLICATION

This application is based upon and claims the benefit of priority from the prior Japanese Patent Application No. 2005-030992, filed on Feb. 7, 2005, the entire contents of which are incorporated herein by reference.

### BACKGROUND OF THE INVENTION

1. Field of the Invention

The present invention relates to a typing-game machine that controls a game based on a judgment of whether or not a character string inputted through key operations agrees with a character string displayed on a display unit, and also to a game system including the typing-game machine.

2. Description of Related Art

A typing game is played for the purpose of practicing typing a keyboard of a word processor or the like. To be specific, for example, a player playing a typing game inputs through a keyboard a character string shown on a display within a predetermined time period, thus learning a key arrangement on the keyboard and a efficient typing technique. As a machine which offers such a typing game, known is a typing-game machine that is placed in a game arcade, etc., and offers a game to many indefinite players for a predetermined charge, a typing-game machine that offers a game playable on an individual PC by installing in the PC a software program purchased by a player.

For the purpose of improving a game feeling, according to a certain known technique, a player not only inputs a character string shown on a display but also inputs words for talking with a character shown on a display or inputs lyrics of a song which is being played. For example, Japanese Patent Unexamined Publication No. 2002-268534 discloses a typing-game machine that does not display a character string on a display but plays a song so that a user inputs lyrics of the song to thereby practice typing based on acoustic information. A typing-game machine which plays a song and makes a user input lyrics of the song may produce an effect of advertising a song which is played during a game, to be more specific, an effect of motivating a player to purchase a CD or a DVD of the song.

For the purpose of further improving the game feeling, it has been proposed that presentation effects be limited in accordance with a game result. The presentation effects include displaying a talking character or a singer singing a song on a display, outputting sounds as voice of the character displayed on the display, musical accompaniment, singing voice, and the like. For example, if the number of mistypings becomes large, a sound output is stopped or a display area on a screen is reduced.

### SUMMARY OF THE INVENTION

If presentation effects are limited in accordance with a game result, an inexperienced player or a player poor at typing must play a game with limited presentation effects. This may decrease motivation of the player for a game. If a sound output is limited particularly in a typing-game machine that plays a song so that a user inputs lyrics of the song, the aforementioned effect of advertising the song cannot fully be obtained.

An object of the present invention is to provide a typing-game machine and a game system including the typing-game machine which can suppress demotivating a player to play a game with a game feeling improved and at the same time with presentation effects fully exhibited.

According to an aspect of the present invention, there is provided a typing-game machine comprises a display unit, a sound output unit, an input unit, a judgment unit, a game control unit, and a presentation-effect limitation unit. The display unit displays a character string for a game. The sound output unit outputs a sound for a game. The input unit has a plurality of keys respectively associated with a plurality of characters. The judgment unit judges whether a character string inputted through the input unit agrees with a character string displayed through the display unit or not. The game control unit controls a game. The presentation-effect limitation unit at least partly limits, based on a judgment result made by the judgment unit, at least one of a display made through the display unit and an output made through the sound output unit. The game control unit controls a game based on either one of a first game mode in which the presentation-effect limitation unit does not work and a second game mode in which the presentation-effect limitation unit works. For a predetermined period of time after a start of a game, the game is controlled based on the first game mode irrespective of the judgment result.

In this aspect, the display made through the display unit and the output made through the sound output unit are limited only when a game is controlled based on the second game mode. They are not limited when a game is controlled based on the first game mode. In addition, for at least a predetermined period of time after a start of a game, the game is controlled based on the first game mode irrespective of the judgment result made by the judgment unit. Therefore, at least for a predetermined period of time, every player can play a game based on the first game mode, thus without any limitation put on the display and the sound output. This can suppress demotivating an inexperienced player or a player poor at typing, and at the same time can fully exhibit presentation effects. In the second game mode, on the other hand, the display made through the display unit and/or the output made through the sound output unit is/are limited based on the judgment result, that is, a result of a typing game. This offers a high game feeling because presentation effects change depending on a game result. Therefore, even if a player repeatedly plays games, he/she can keep enjoying the games without getting tired.

### BRIEF DESCRIPTION OF THE DRAWINGS

Other and further objects, features and advantages of the invention will appear more fully from the following description taken in connection with the accompanying drawings in which:

FIG. 1 is a perspective view of a typing-game machine according to a first embodiment of the present invention;

FIG. 2 schematically shows what is displayed on a main display of the typing-game machine before a game is started;

FIGS. 3A and 3B schematically show what are displayed during a game on a sub display and the main display of the typing-game machine, respectively, if a song of a male singer is selected;

FIGS. 4A and 4B schematically show what are displayed during a game on the sub display and the main display of the typing-game machine, respectively, if a song of a female singer is selected;

FIG. 5 schematically shows what is displayed on the main display after a game is finished;

FIG. 6 shows a determination table used for determining whether a sound output should be limited or not;

FIG. 7 shows a limit determination table used for determining how a sound output should be limited;

FIG. 8 is a plan view of a keyboard of the typing-game machine;

FIG. 9 is a sectional view of a key that is arranged on the keyboard;

FIG. 10 is a block diagram showing a game system that includes many typing-game machines and a server;

FIG. 11 is a block diagram showing a control unit of the typing-game machine;

FIG. 12 shows a song data storage area within an HDD that is included in the control unit;

FIG. 13 shows a flowchart of a main processing that is executed in the typing-game machine;

FIG. 14 shows a flowchart of a song selection processing that is included in the main processing;

FIG. 15 shows a flowchart of a typing game execution processing that is included in the main processing;

FIG. 16 shows a flowchart of a presentation-effect limitation processing that is included in the typing game execution processing;

FIG. 17 shows a determination table according to a second embodiment, used for determining whether a sound output should be limited or not; and

FIG. 18 shows a flowchart of a presentation-effect limitation processing according to the second embodiment.

### DESCRIPTION OF THE PREFERRED EMBODIMENTS

In the following, some preferred embodiments of the present invention will be described with reference to the accompanying drawings.

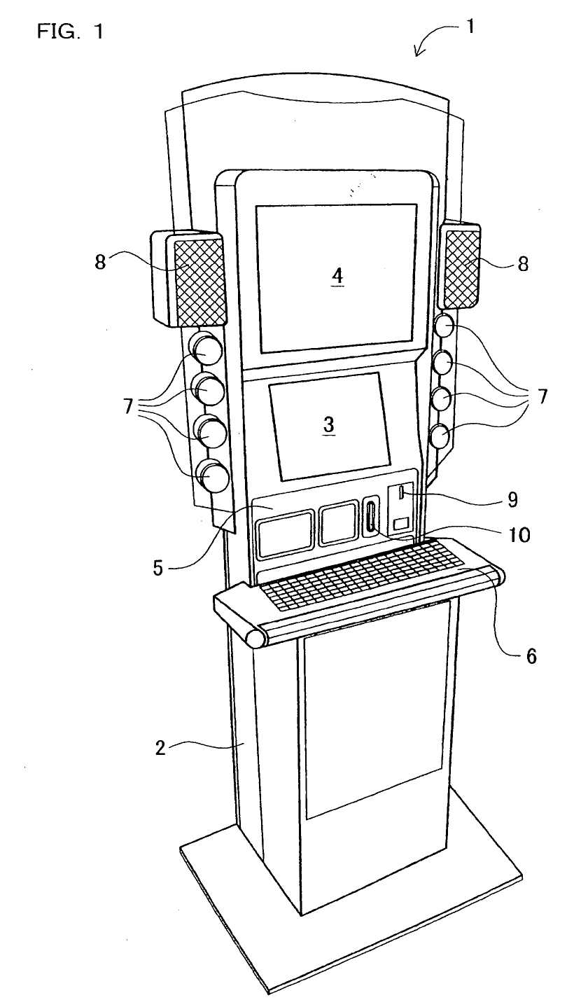

First, a typing-game machine 1 according to a first embodiment will be described. The typing-game machine 1 is of a cabinet type and placed in a game arcade or the like. As illustrated in FIG. 1, the typing-game machine 1 includes a cabinet 2, a main display 3, a sub display 4, a center panel 5, a keyboard 6, eight external lights 7, and a pair of speakers 8. In order to play a game in the typing-game machine 1, a player, who is hearing a song outputted from the speakers 8 and at the same time watching lyrics of the song displayed on the main display 3, inputs the lyrics through the keyboard 6.

The main display 3 is a liquid crystal display, and disposed substantially in the middle of a front face of the cabinet 2. The main display 3 leans back at a predetermined angle. The main display 3 displays game information which concerns a progress of a game, that is, information necessary for a player to progress a game. The game information includes lyrics of a song that is outputted during a game through the speakers 8, a game result, a score associated with the game result, and the like.

The sub display 4 disposed above the main display 3 is also a liquid crystal display similarly to the main display 3. The sub display 4 displays an effect image such as a promotion video (hereinafter abbreviated as ‘PV’), an advertisement, and the like. The effect image differs from the game information displayed on the main display 3 in that the effect image is not directly involved in a progress of a game but has a supplementary function for enhancing amusement of a game.

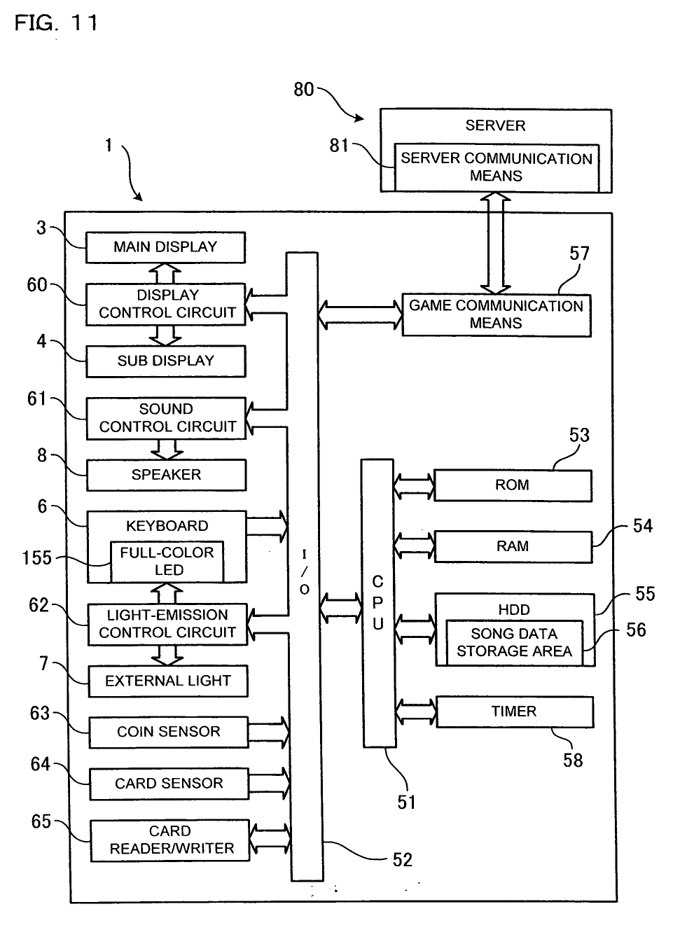

The center panel 5 is disposed under the main display 3, and has a coin insertion slot 9 and a card insertion slot 10. A coin such as a 100 yen coin, which is used as a charge for a game, is inserted into the coin insertion slot 9. A coin sensor 63 for detecting a coin is disposed in the coin insertion slot 9 (see FIG. 11). Thus, when a coin is inserted into the coin insertion slot 9, the coin sensor 63 outputs a detection signal to a CPU 51.

An IC card (not illustrated) is inserted into the card insertion slot 10. The IC card has an IC tag. The IC tag stores results of games previously played by an owner of this IC card, in more detail, scores, points, etc., previously marked by the owner. A card sensor 64 and a card reader/writer 65 are disposed in the card insertion slot 10 (see FIG. 11). The card sensor 64 detects an IC card inserted into the card insertion slot 10. The card reader/writer 65 reads and writes data out of and into the IC tag of the IC card.

The keyboard 6 is disposed on the front face of the cabinet 2 in such a manner as to protrude frontward. The keyboard 6 is operated in order to select a song and a game level before a game is started, and also operated in starting a game and during a game.

Four of the external lights 7 are disposed on the right side of the main display 3, and four of them are disposed on the left side of the main display 3. The external lights 7 include full-color LEDs capable of emitting full-color lights, so that they produce various lighting effects in accordance with a song which is being played. The lighting effects include, for example, simultaneously changing light colors emitted from all the eight external lights 7, changing light colors based on a regular rule, turning on and off the external lights 7, and the like.

The speakers 8 are disposed on right and left sides of the sub display 4, and outputs a song (which means a combination of accompaniment and singing voice) and effect sounds. To be more specific, during a game the speakers 8 outputs accompaniment and singing voice at a predetermined tempo, based on accompaniment data and singing voice data stored in the HDD (see FIG. 11).

Next, a description will be given to contents of displays shown on the main display 3 and the sub display 4. The contents of displays include three patterns, i.e., a pre-game pattern, an in-game pattern, and an after-game pattern.

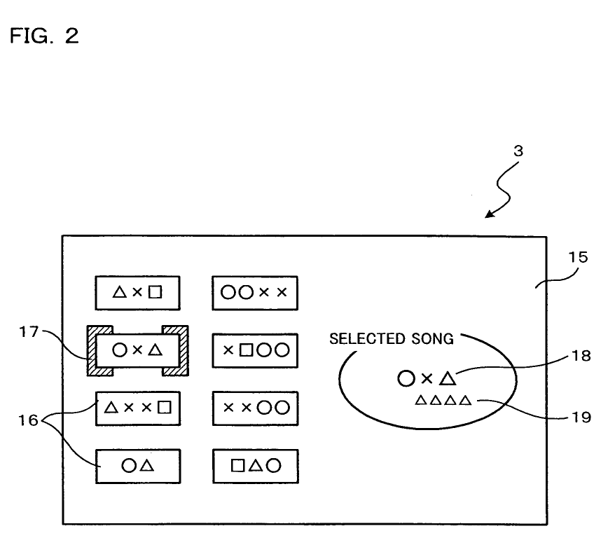

With reference to FIG. 2, a description will be given to what is displayed in a case where a coin/coins of a predetermined amount is/are inserted into the coin insertion slot 9 but a game is not started yet. The main display 3 displays a song selection screen 15. The song selection screen 15 has a song title indicator 16, a cursor 17, a selected song indicator 18, and a singer name indicator 19. While the main display 3 is displaying the song selection screen 15, the sub display 4 may display a PV, an advertisement, etc., of an arbitrary song.

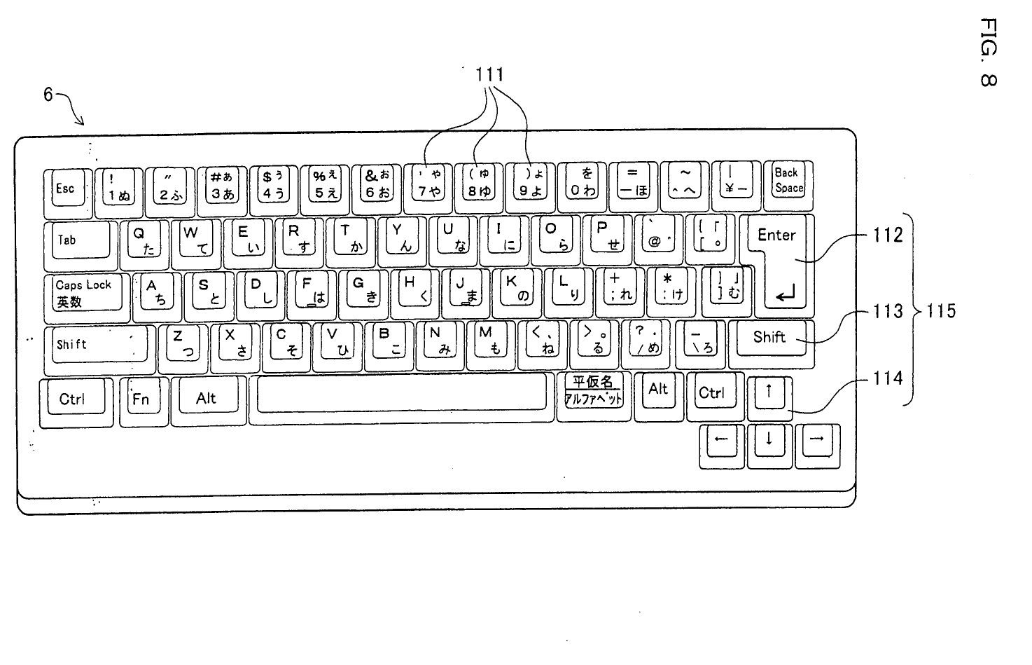

The song title indicator 16 indicates titles of songs available for a game in the typing-game machine 1. By operating cursor keys 114 of the keyboard 6 (see FIG. 8), the cursor 17 can be moved over the song title indicator 16 in vertical and horizontal directions. The selected song indicator 18 indicates a title of a song which is currently pointed by the cursor 17, and the singer name indicator 19 indicates a name of a singer of a song which is currently pointed by the cursor 17. When an enter key 112 (see FIG. 8) is pressed with the cursor 17 pointing a song, a song used for a game is determined and a typing game starts.

FIG. 10 shows a game system including typing-game machines 1. In the game system, each of the typing-game machines 1 is connected to a server 80 through a network N capable of two-way communication, e.g., through an internet. Song data are stored in the HDD 55 of the typing-game machine 1 (see FIG. 11) and indicated by the song title indicator 16. These song data are updated by downloading data from the server 80. Accordingly, songs available for a game on the typing-game machine 1 can be changed, and thus a player can play with a latest song. Further, according to the game system, if the server 80 manages all of many typing-game machines 1 placed in a game shop, updating data can easily be done.

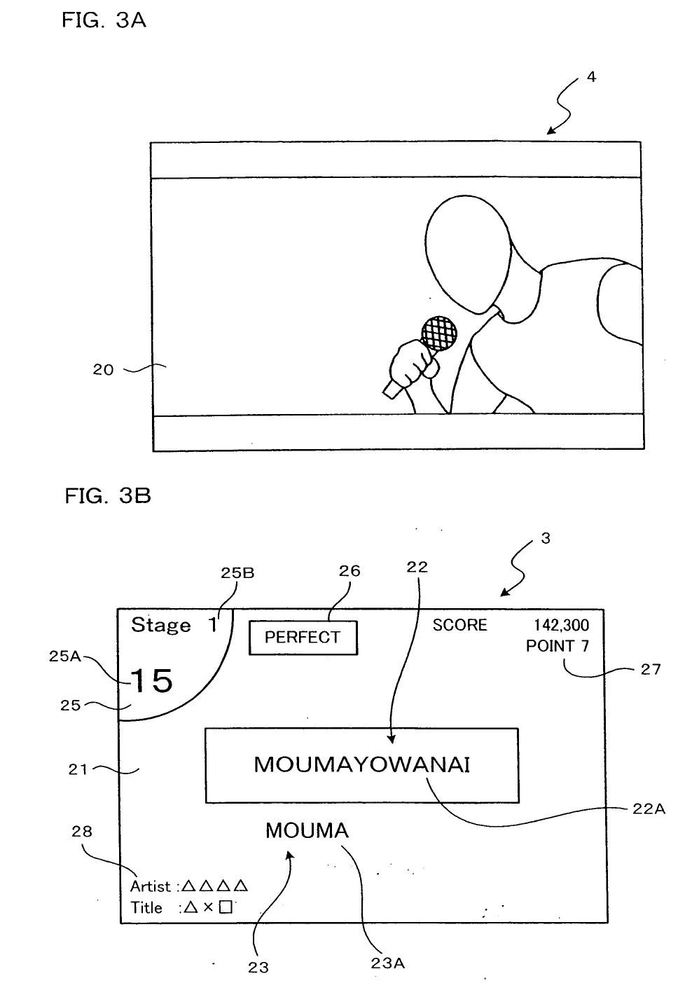

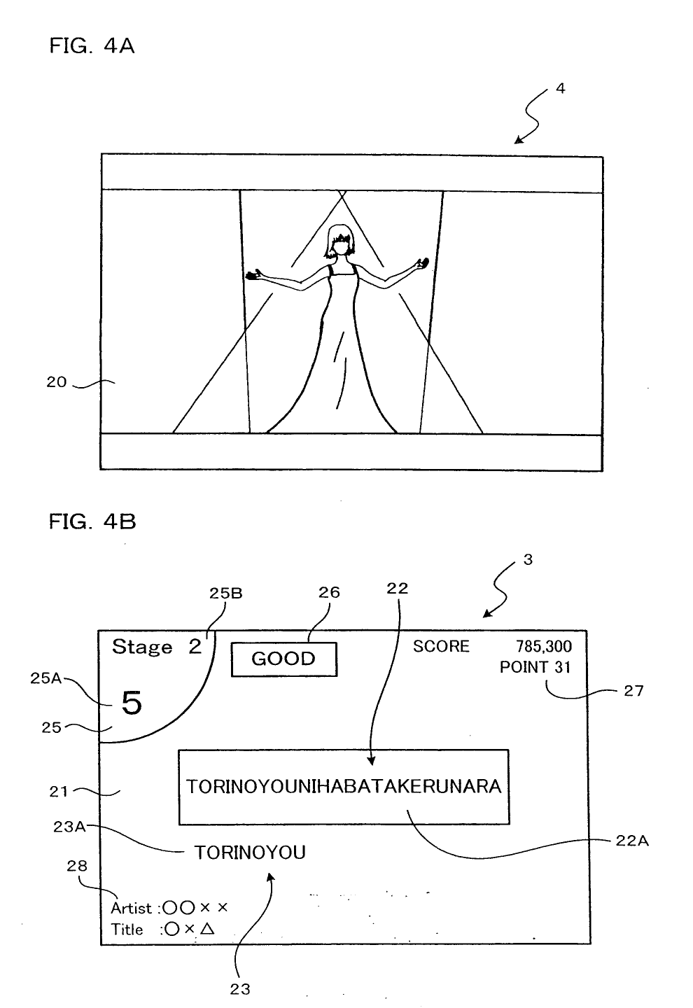

With reference to FIGS. 3A, 3B, 4A, and 4B, a description will be given to what is displayed during a game. During a game, the main display 3 displays a main game screen 21 which concerns a progress of a game, and the sub display 4 displays a PV 20 of the song selected.

Each song used for a game includes some pieces, i.e., some stages. Each of the some stages includes some phrases of lyrics of a song. A game starts with a first stage in which a user, while hearing a song, sequentially inputs characters of phrases included in this stage. If a later-described predetermined requirement is satisfied at the end of this stage, the user is allowed to proceed to a next stage.

The main game screen 21 includes a lyrics indicator 22, an inputted character indicator 23, a stage-number/phrase-number indicator 25, a game result indicator 26, a record indicator 27, and a singer-name/song-title indicator 28.

The lyrics indicator 22 indicates a character string 22A exhibiting one phrase of lyrics of a song used for a game. The character string 22A is displayed following a song being played. In FIGS. 3B and 4B, the character string 22A is designated in Japanese using Roman characters. A player inputs characters in accordance with the character string 22A indicated by the lyrics indicator 22, thus progressing a game.

The inputted character indicator 23 indicates characters 23A which have already been inputted by a player among characters included in the character string 22A indicated by the lyrics indicator 22. The character string 23A lets a player know which characters he/she has already inputted.

The stage-number/phrase-number indicator 25 has a stage-number indicator 25B and a phrase number indicator 25A. The stage-number indicator 25B indicates an ordinal number of a stage to which a phrase currently indicated by the lyrics indicator 22 belongs. The phrase number indicator 25A indicates an ordinal number which is, within each stage, assigned to a phrase currently indicated by the lyrics indicator 22. For example, if a song includes three pieces, there exist first, second, and third stages. FIG. 3B illustrates that a phrase currently indicated by the lyrics indicator 22 is the 15th phrase of the first stage, and FIG. 4B illustrates that a phrase currently indicated by the lyrics indicator 22 is the 5th phrase of the second stage.

Every time a player finishes inputting one phrase, a value indicated by the phrase number indicator 25A increases by one. Every time a player finishes inputting all phrases included in one stage, a value indicated by the stage number indicator 25B increases by one. The stage-number/phrase-number indicator 25 lets a player know a stage number and a phrase number he/she currently participates in.

The game result indicator 26 indicates a judgment about correctness of the typing. If a player has inputted correct characters in time with singing voice, the game result indicator 26 indicates “PERFECT”. If a player has inputted correct characters not in time with singing voice, the game result indicator 26 indicates “GOOD”. If a player has inputted incorrect characters, the game result indicator 26 indicates “MISS” irrespective of timing of the input.

The record indicator 27 indicates a score and points which have been marked by a player until now. If a player has correctly inputted characters in accordance with the character string 22A indicated by the lyrics indicator 22, a score is added. If this input was done in time with singing voice, an additional score is further added. If a player has inputted all characters included in one phrase without any mistake, one point is added.

The song information indicator 28 indicates a title of a song which is being used for a game and a name of a singer of the song.

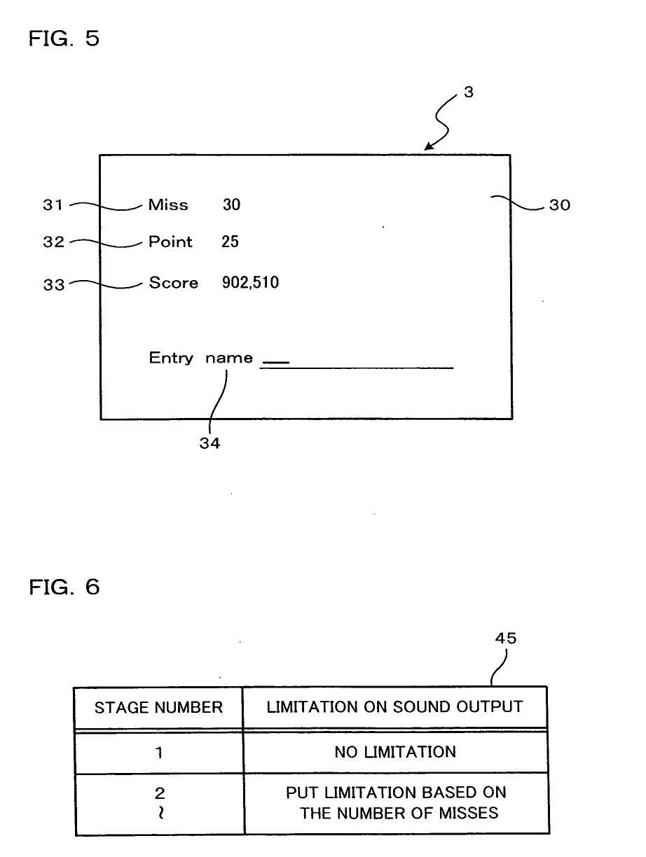

With reference to FIG. 5, a description will be given to what is displayed after a game is finished. The main display 3 displays a game result screen 30 showing a result of the last game. The game result screen 30 includes a number-of-misses indicator 31, an acquired-point indicator 32, a marked-score indicator 33, and a name-input indicator 34. The number-of-misses indicator 31 indicates the number of mistypings made in the last game. The acquired-point indicator 32 and the marked-score indicator 33 indicate a point acquired and a score marked, respectively.

The game result screen 30 lets a player know the number of misses made in the last game, a point acquired in the last game, and a score marked in the last game. When a player inputs his/her name through the keyboard 6 while the main display 3 is displaying the game result screen 30, the inputted name is indicated by the name-input indicator 34. If the score reaches a predetermined value or higher, the name and the score are entered on a ranking, and ranking data that are stored in a RAM 54 (see FIG. 11) are updated.

While the main display 3 is displaying a game result screen 30, the sub display 4 may display a PV, an advertisement, etc., of an arbitrary song.

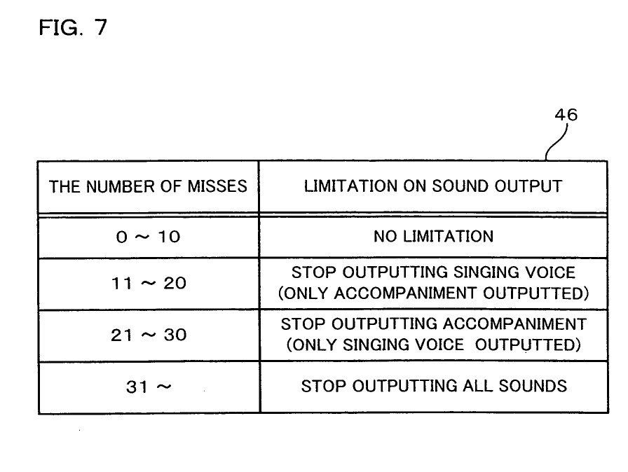

Next, a limitation on a sound output will be described with reference to FIGS. 6 and 7.

A determination table 45 shown in FIG. 6 is for determining, based on a stage number of a current song, whether outputting accompaniment and outputting singing voice should be limited or not during a game. If a stage number of a current song is “first”, a sound output is not limited and the speakers 8 output both accompaniment and singing voice. If a stage number of the song is “second”, a sound output is limited in accordance with the number of mistypings made.

A limit determination table 46 shown in FIG. 7 is for determining how a sound output should be limited based on the number of mistypings. For example, if the number of mistypings is equal to or less than ten, a sound output is not limited and the speakers 8 output both accompaniment and singing voice. If the number of mistypings is eleven to twenty, the output of singing voice is stopped and only accompaniment is outputted. If the number of mistypings is twenty-one to thirty, the output of accompaniment is stopped and only singing voice is outputted. If the number of mistypings is equal to or more than thirty-one, the sound output of accompaniment and the sound output of singing voice are both stopped.

The determination table 45 and the limit determination table 46 are stored in a ROM 53 (see FIG. 11).

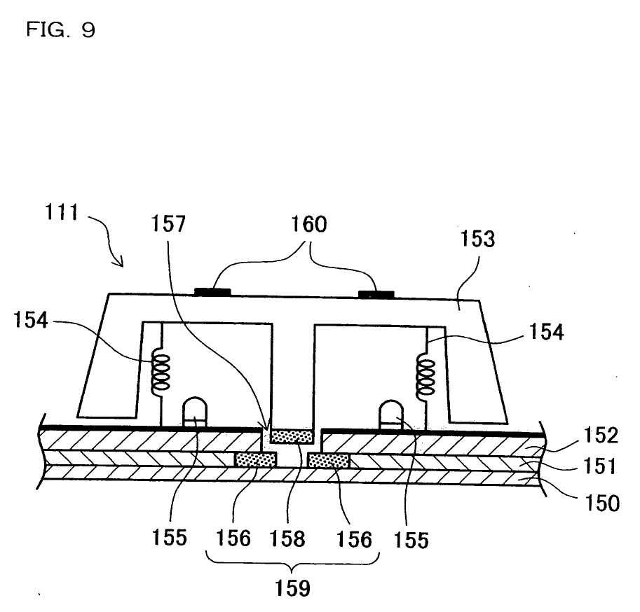

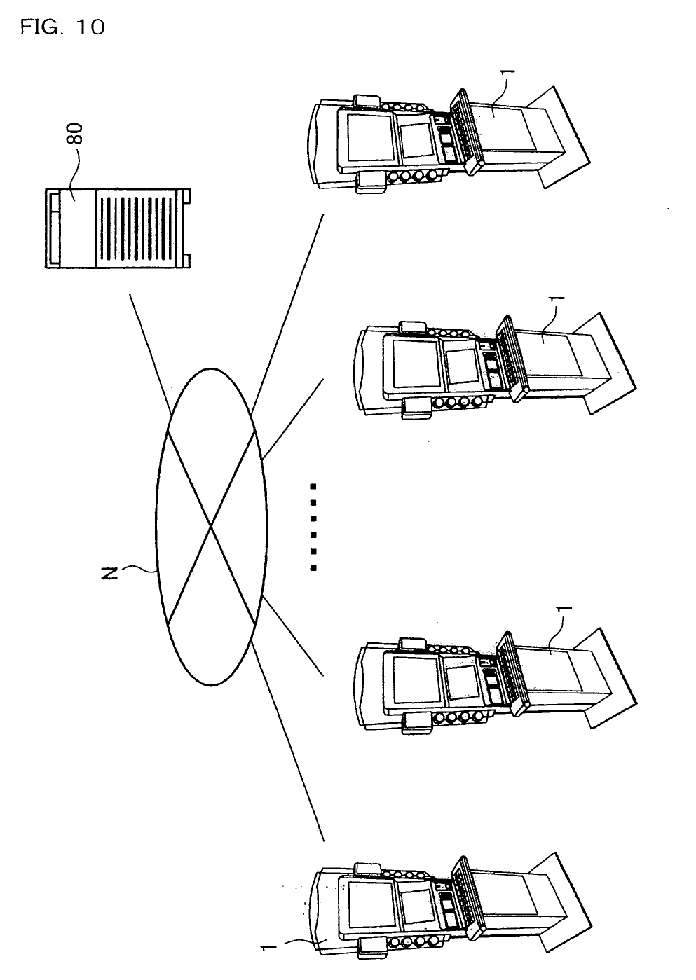

Next, the keyboard 6 will be described with reference to FIGS. 8 and 9.

As illustrated in FIG. 8, the keyboard 6 is a Japanese 108 keyboard on which character input keys 111 and function keys 115 are arranged. The character input keys 111 are for inputting characters of “A to Z (alphabets)”, “A to N (kanas), “0 to 9 (figures)”, and marks such as (period)”, “, (comma)”, etc. The function keys 115 include an enter key 112, a shift key 113, cursor keys 114, etc. Here, in FIG. 8, actual Japanese kana characters are shown. A player operates the character input keys 111 during a game, and operates the function keys 115 in order to start a game, in order to select a song and a game level before starting a game, and the like.

Each of the keys of the keyboard 6 has an internal structure shown in FIG. 9. FIG. 9 shows a character input key 111 as an example, but the other function keys 115 have the same structure and therefore a specific description thereof will be omitted here.

As shown in FIG. 9, each of the keys of the keyboard 6 has a base plate 150, a switching circuit board 151, a light-emitting circuit board 152, a key top 153, a biasing mechanism 154, and a full-color LED 155. The biasing mechanism 154 is disposed between the light-emitting circuit board 152 and a top wall of the key top 153, so that the biasing mechanism 154 biases the key top 153 upward to be away from the switching circuit board 151. The biasing mechanism 154 is not limited to one having only an elastic member as shown in FIG. 9, but may be one having an elastic member and a bridge mechanism.

The switching circuit board 151 disposed on the base plate 150 has a pair of electrodes 156 that correspond to a center of the key top 153. The light-emitting circuit board 152 disposed on the switching circuit board 151 has an opening 157 for exposing the electrodes 156. The key top 153 has an extending portion that extends from a center of the top wall of the key top 153 toward the opening 157. An electrode 158 is provided at a front end of the extending portion so that it may confront the electrodes 156. The full-color LED 155 is disposed on the light-emitting circuit board 152 and around the opening 157.

A key switch 159, which is made up of the electrodes 156 and 158, is connected to a signaling circuit (not shown) provided on the switching circuit board 151. The signaling circuit is connected through an interface unit 52 (hereinafter referred to as “I/O”) to the CPU 51 of the typing-game machine 1 (see FIG. 11). When the key top 153 is pressed down, the electrode 158 of this key top 153 comes into contact with the electrodes 156 and a press-down signal is transmitted from the key switch 159 through the signaling circuit to the CPU 51. The CPU 51 thereby identifies which key is pressed down, and controls for executing an operation corresponding to this key.

The key top 153 is made of a translucent material such as transparent acryl, a transparent plastic, etc. On an upper face of the key top 153, key information 160 such as a character, a figure, a mark, etc., is printed with black color. An upper face of the light-emitting circuit board 152 is also printed with black. Accordingly, while the full-color LED 155 is turned off, the key information 160 is not much seeable because it overlaps the black upper face of the light-emitting circuit board 152. While the full-color LED 155 is turned on, the black key information 160 can easily be seen because the translucent key top 153 reflects a lighting color of the full-color LED 155.

The full-color LED 155 is connected to a light-emission control circuit 62 that is connected through the I/O 52 to the CPU 51 (see FIG. 11). The light-emission control circuit 62 causes the full-color LED 155 to light with a color determined by the CPU 51. For example, if it is judged that a correct character has been inputted, the light-emission control circuit 62 causes a character input key 111 which has been pressed down to emit a blue light. If it is judged that an incorrect character has been inputted, the light-emission control circuit 62 causes a character input key 111 which has been pressed down to emit a red light and a correct key which should have been pressed down to emit a green light, respectively. If no character has been inputted, the light-emission control circuit 62 causes a correct key which should have been pressed down to emit a green light.

Next, a control unit of the typing-game machine 1 will be described with reference to FIG. 11.

As shown in FIG. 11, the control unit includes a CPU 51, a ROM 53, a RAM 54, an HDD 55, a timer 58, and peripheral equipments. The ROM 53, the RAM 54, the HDD 55, and the timer 58 are connected to the CPU 51. The peripheral equipments are connected through the I/O 52 to the CPU 51.

The CPU 51 is a central processing unit that executes computations in accordance with various commands. The I/O 52 electrically connects, to the CPU 51, the main display 3, the sub display 4, the keyboard 6, the external lights 7, the speakers 8, and the like. The ROM 53 is a non-volatile read-only memory that stores the determination table 45 (see FIG. 6), the limit determination table 46 (see FIG. 7), a computation program for executing a later-described flowchart, and the like. The RAM 54 is a memory for temporarily storing data computed out by the CPU 51, and stores the number of mistypings made, a score, a point, a current stage number, etc. Further, the RAM 54 temporarily stores, among song data stored in the HDD 55, data about lyrics of a song used for a game. The lyrics stored in the RAM 54 are divided on a phrase basis.

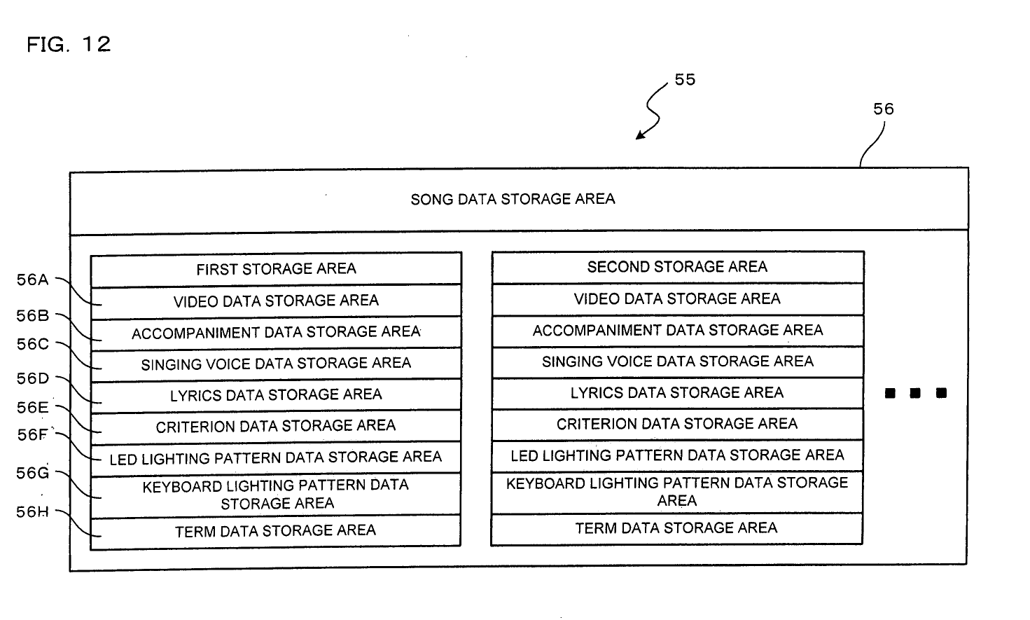

The HDD 55 is a storage device that stores song data available for a game in the typing-game machine 1. The song data include video data, accompaniment data, singing voice data, lyrics data, criterion data, LED lighting pattern data, keyboard lighting pattern data, and term data. These data are stored in respective storage areas in a song data storage area 56 that is formed in the HDD (see FIG. 12).

Here, the song data storage area 56 formed in the HDD 55 will be described with reference to FIG. 12.

The HDD 55 is capable of storing data of eight songs, and the song data storage area 56 has first to eight storage areas which are data storage areas each corresponding to each song. Each of the first to eight storage areas includes a video data storage area 56A, an accompaniment data storage area 56B, a singing voice data storage area 56C, a lyrics data storage area 56D, a criterion data storage area 56E, an LED lighting pattern data storage area 56F, a keyboard lighting pattern data storage area 56G, and a term data storage area 56H.

The video data storage area 56A stores video data concerning the PV 20 which is displayed on the sub display 4 (see FIGS. 3A and 4A). The accompaniment data storage area 56B stores instrumental accompaniment data concerning a song which is outputted from the speakers 8. The singing voice data storage area 56C stores data concerning singing voice which is outputted from the speakers 8. The lyrics data storage area 56D stores lyrics data concerning lyrics of a song.

The criterion data storage area 56E stores criterion data concerning a criterion for judgment about correctness of a typing, that is, judgment about correctness of an inputted character and correctness of an input timing. The LED lighting pattern data storage area 56F stores LED lighting pattern data for lighting the external lights 7. The keyboard lighting pattern data storage area 56G stores keyboard lighting pattern data for lighting the full-color LEDs 155 that are provided inside the keys. Lighting patterns of the full-color LED 155 include one which assists a player in typing by means of sequentially lighting a series of keys which should be pressed down with a light color thereof different from a light color of the other keys, one which changes light colors of all the keys arranged on the keyboard 6 so as to match with impression given by a song, and the like.

The term data storage area 56H stores term data concerning an expiration date of the song data. The term data include two data items, one about a start date of using song data and one about an end date of using song data. To be more specific, the start date is a date on which song data is transmitted from the server 80 (see FIG. 10) and gets available in a typing-game machine 1, and the end date is a date after a predetermined period of time elapses from the start date. Based on data obtained from the timer 58 (see FIG. 11) and the term data stored in the term data storage area 56H, the CPU 51 manages expiration dates of respective song data so that an expired song data may not be used for a game.

Referring to FIG. 11 again, the other peripheral equipments included in the control unit will be described.

A game communication unit 57 converts a signal sent out from the typing-game machine 1 into a transmittable form according to a communication type such as a telephone network, a LAN cable, etc., and then sends the signal thus converted to the server 80. Also, the game communication unit 57 converts a signal sent from the server 80 into a form readable by the typing-game machine 1, and then receives the signal thus converted. The game communication unit 57 is connected to a server communication unit 81 of the server 80 through a network N capable of two-way communication, e.g., through an internet (see FIG. 10).

A display control circuit 60 is connected through the I/O 52 to the CPU 51, and controls contents of displays on the main display 3 and the sub display 4 in accordance with results of computing processing executed by the CPU 51. The display control circuit 60 includes a program ROM, an image ROM, an image control CPU, a work RAM, a VDP (Video Display Processor), a video RAM, and the like. The program ROM stores an image control program, various selection tables, etc., which concern displays made on the main display 3 and the sub display 4. The image ROM stores dot data used for forming images such as a song selection screen 15 (see FIG. 2), a main game screen 21 (see FIGS. 3B and 4B), a game result screen 30 (see FIG. 5), which are displayed on the main display 3. Based on a parameter defined by the CPU 51 and in accordance with the image control program stored in the program ROM, the image control CPU determines, from the dot data stored in the image ROM, which image will be displayed on the main display 3 and the sub display 4. The VDP forms an image that corresponds to display contents determined by the image control CPU, and outputs the image to the main display 3 or the sub display 4.

A sound control circuit 61 is connected through the I/O 52 to the CPU 51, and also connected to the speakers 8. When a game is started and song data are read out of the song data storage area 56 of the HDD 55, accompaniment data and singing voice data included in the song data are converted into a tone signal by the sound control circuit 61 and then outputted through the speakers 8. If a predetermined requirement which will be described later is satisfied, a sound output is controlled by the sound control circuit 61.

A light-emission control circuit 62 is connected through the I/O 52 to the CPU 51, and also connected to the external lights 7 (see FIG. 1) and to the full-color LEDs 155 disposed inside the keys (see FIG. 9). When song data are read out of the song data storage area 56 of the HDD 55, the light-emission control circuit 62 controls the external lights 7 and the full-color LEDs 155 based on LED lighting pattern data and keyboard lighting pattern data included in the song data.

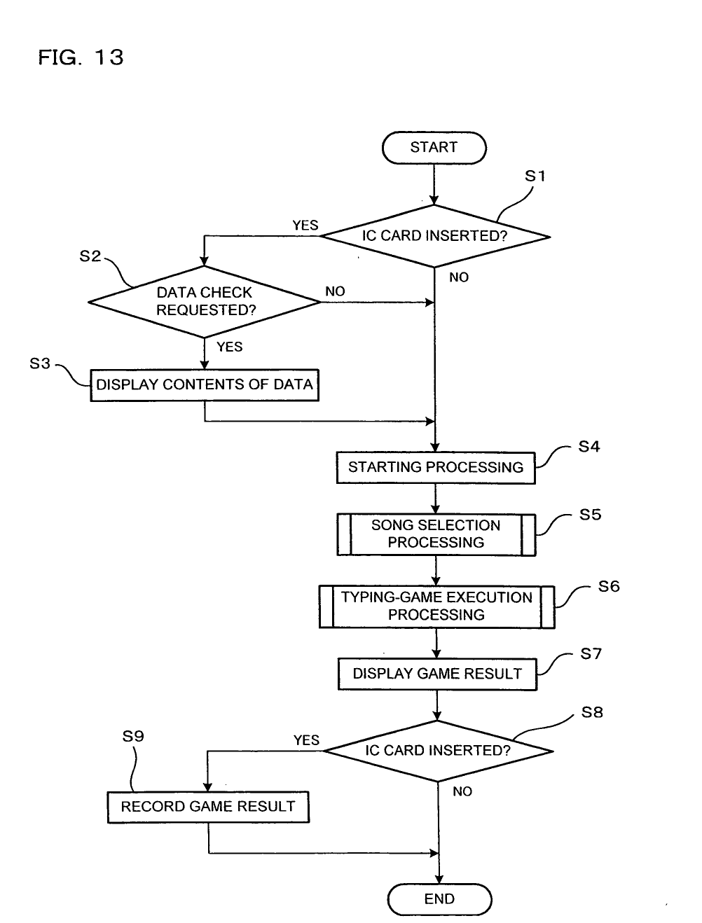

Next, processings executed in the typing-game machine 1 will be described with reference to FIGS. 13, 14, 15, and 16. Programs of the processings shown in FIGS. 13 to 16 are stored in the ROM 53 or RAM 54, and the CPU 51 executes these programs.

A description will be given to a main processing shown in FIG. 13.

First, whether an IC card is inserted in the card insertion slot 10 or not is judged based on a detection signal sent from the card sensor 64 (S1). If it is judged that an IC card is inserted (S1: YES), whether a player requests a data check or not is judged (S2). If it is judged that an IC card is not inserted (S1: NO), the processing proceeds to S4.

If it is judged that a player requests a data check (S2: YES), the card reader/writer 65 reads out data stored in a IC tag of the IC card, that is, results of games previously played by the owner of this IC card. Then, the results of games are listed on the main display 3 (S3). By, for example, pressing down a shift key 113 of the keyboard 6, a player can request a data check and check results of previous games.

In S4, a starting processing is executed. Specifically, whether a predetermined amount of coins, e.g., for 200 yen, are inserted into the coin insertion slot 9 or not is judged based on a detection signal sent from the coin sensor 63. If it is judged that a predetermined amount of coins are inserted, the processing proceeds to S5.

While a predetermined amount of coins are not yet inserted during the starting processing S4, and while the typing-game machine 1 is in a stand-by state holding no player, the sub display 4 and/or the main display 3 displays a demonstration screen including a demo-play game, a PV of an arbitrary song, an advertisement, a list of ranking data, and the like.

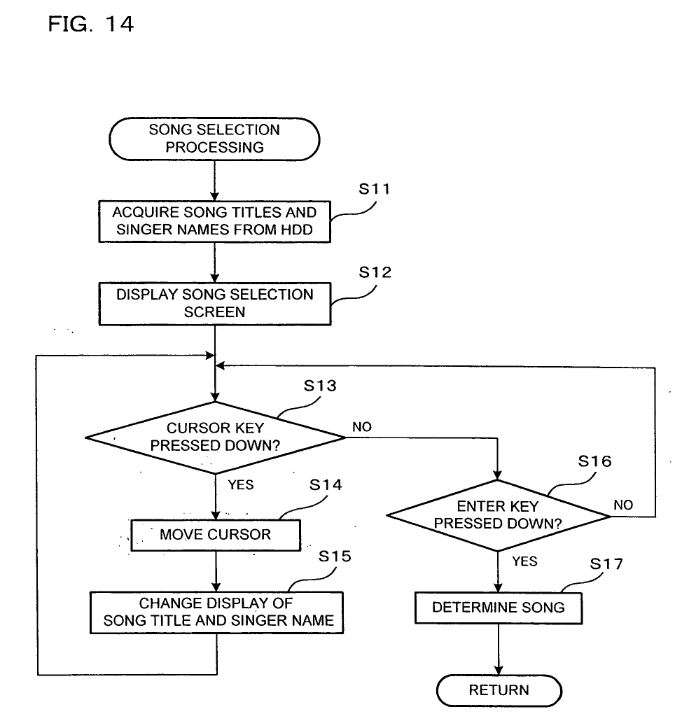

In S5, a song selection processing shown in FIG. 14 is executed. In the song selection processing, as will be detailed later, the main display 3 displays a song selection screen 15 (see FIG. 2) based on song data stored in the song data storage area 56 of the HDD 55, so that a song used for a game is determined.

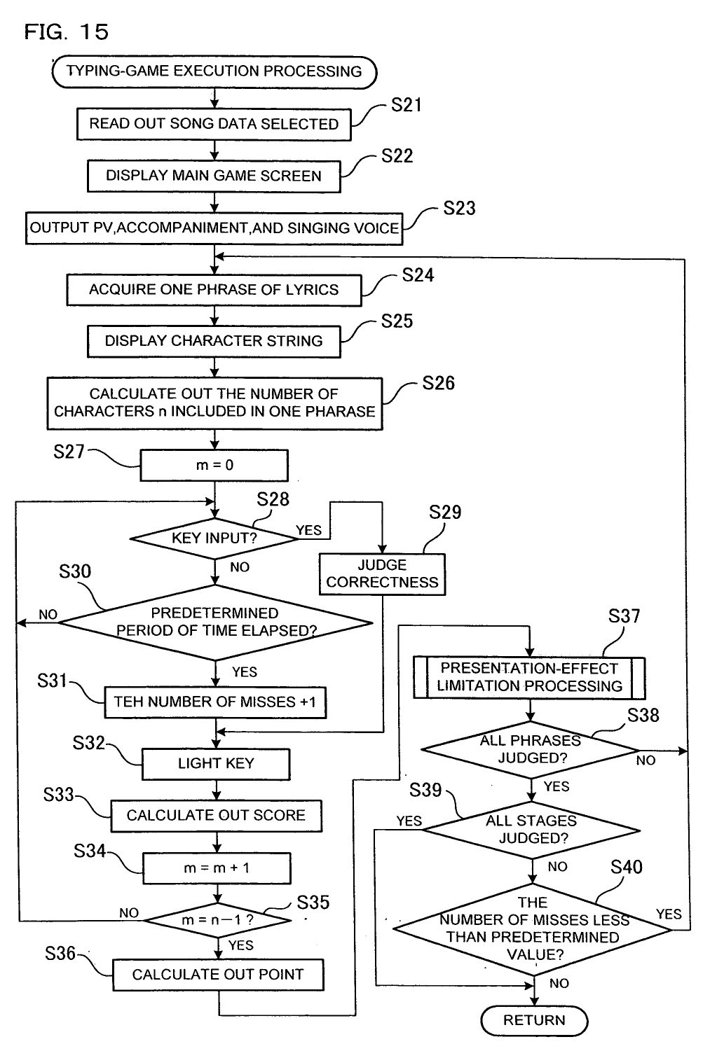

In S6, a typing-game execution processing shown in FIG. 15 is executed based on a song determined in S5. In the typing-game execution processing, as will be detailed later, a game continues until a predetermined requirement for exiting is satisfied. During the game, accompaniment and singing voice are outputted, and in this state the number of mistypings, a score, and a point are accumulated based on typings made by the player.

When the typing-game execution processing ends, the main display 3 displays the game result screen 30 (see FIG. 5) based on a result of the game played in S6 (S7). Then, as described above, the player inputs his/her name through the keyboard 6 so that the inputted name is indicated by the name-input indicator 34. If the score reaches a predetermined score or higher, the name and the score are entered on a ranking, and ranking data that are stored in a RAM 54 (see FIG. 11) are updated.

Then, whether an IC card is inserted in the card insertion slot 10 or not is judged based on a detection signal sent from the card sensor 64 (S8). If it is judged that an IC card is not inserted (S8: NO), the main processing ends. If it is judged that an IC card is inserted (S8: YES), the card reader/writer 65 writes the result of the last game stored in the RAM 54, that is, the score and the point acquired, into an IC tag of the IC card (S9). Then, the main processing ends. Data about the game result thus written into the IC tag in S9 can be displayed in S3, if a data check is requested in S3.

The song selection processing S5 included in the main processing will be described with reference to FIG. 14.

First, titles and singer names for all songs stored in the song data storage area 56 of the HDD 55 are acquired (S11). Based on the song titles and the singer names thus acquired, the main display 3 displays a song selection screen 15 (see FIG. 2) (S12).

Then, whether a cursor key 114 is pressed down or not is judged based on a press-down signal sent from the keyboard 6 (S13). If it is judged that a cursor key 114 is pressed down (S13: YES), a cursor 17 appearing on the main display 3 is moved in a direction indicated by the pressed-down cursor key 114 among the cursor keys 114 which indicate up, down, left, and right, respectively (S14).

A song title and a singer name indicated by the selected song indicator 18 and the selected singer name indicator 19 are renewed into ones pointed by the cursor 17 which has been moved in S14 (S15). Then, the processing returns to a judgment step S13.

If it is judged that a cursor key 114 is not pressed down (S13: NO), whether an enter key 112 is pressed down or not is judged (S16). If it is judged that an enter key 112 is pressed down (S16: YES), a song currently pointed by the cursor 17 is determined as a song used for this game (S17) and a game starts. If it is judged that an enter key 112 is not pressed down (S16: NO), the processing returns to the judgment step S13.

The typing-game execution processing S6 included in the main processing will be described with reference to FIG. 15.

First, read out of the HDD 55 are song data stored in the song data storage area 56. These song data is about a song selected in the song selection processing S5 (S21). Lyrics data stored in the lyrics data storage area 56D are divided on a phrase basis, and temporarily stored in the RAM 54.

Then, the main display 3 displays the main game screen 21 (see FIGS. 3B and 4B) (S22). At this time, the lyrics indicator 22 and the inputted character indicator 23 do not indicate a character string or any characters, and the record indicator 27 indicates a score of “0”.

Then, a PV 20 (see FIGS. 3A and 4A), accompaniment, and singing voice are outputted (S23). To be more specific, the sub display 4 displays a PV 20 for the selected song, based on video data stored in the video data storage area 56A. In addition, through the speakers 8, accompaniment is outputted based on accompaniment data stored in the accompaniment data storage area 56B and singing voice is outputted based on singing voice data stored in the singing voice data storage area 56C.

Subsequently, one phrase of the lyrics data stored in the RAM 54 is acquired (S24), and a character string 22A corresponding to the acquired phrase is indicated by the lyrics indicator 22 of the main game screen 21 (S25). Further, the number of characters n included in the acquired phrase is calculated out (S26), and then “0” is substituted for a given variable m stored in the RAM 54 (S27).

Whether a key input is done through a character input key 111 or not is judged based on a press-down signal sent from the keyboard 6 (S28). If it is judged that a key input is done (S28: YES), correctness of the typing, that is, correctness of the inputted character and input timing is judged based on a press-down signal sent from the key and the criterion data stored in the criterion data storage area 56E (S29). To be more specific, judged are whether a key that is associated with the character string 22A indicated by the lyrics indicator 22 of the main game screen 21 was pressed down or not, and whether the input was done in time with the singing voice. If a key different from the associated key was pressed down, it is judged that an incorrect character was inputted. Thus, the number of mistyping increases by one. Then, the processing proceeds to S32.

If it is judged that a key input was not done (S28: NO), whether a predetermined period of time has elapsed or not is judged based on data obtained from the timer 58 (S30). If it is judged that the predetermined period of time has not elapsed (S30: NO), the processing returns to S28. If it is judged that the predetermined period of time has elapsed (S30: YES), the number of mistypings increases by one (S31).

Here, with respect to an input of a first character of one phrase, a measurement of the predetermined period of time starts when the character string 22A is shown in the main game screen 21 (S25). With respect to an input of a character other than the first character, a measurement of the predetermined period of time starts when a score is calculated out (S33).

In S32, the full-color LED 155 disposed inside the key of the keyboard 6 emits a light. Specifically in the typing-game machine 1 according to the first embodiment, if it is judged that a key input was done (S28: YES) with a correct character inputted, the pressed-down character input key 111 emits a blue light. If it is judged that a key input was done (S28:YES) with an incorrect character inputted, the pressed-down character input key 111 emits a red light and at the same time a correct key which should have been pressed down emits a green light. If no key input was done (S28: NO), a correct key which should have been pressed down emits a green light.

Then, in S33, a score is calculated out based on the judgment about correctness made in S29. If it was judged in S29 that a correct character was inputted, a score is added. If it was judged in S29 that the input was done in time with the singing voice, an additional score is added.

Subsequently, the variable m stored in the RAM 54 is read out and increased by one, and then stored again. Then, judgment is made on whether the variable m reaches n−1 or not, that is, whether inputs of all the characters included in one phrase have been judged or not. If it is judged that the variable m does not yet reach n−1 (S35: NO), the processing returns to S28 in which an input of the next character of the one phrase is judged.

The variable m is a variable used for judging an input of each character included in one phrase. Every time a judgment about an input of one character completes, the variable m is increased by one (S34). Accordingly, when m equals t(0≦t≦n−1), an input of a (t+1)-th character, as counted from a top of the phrase, is judged in S28 to S35. [0088] If it is judged that the variable m reaches n−1 (S35: YES), that is, if all the characters included in one phrase have been inputted, a point is calculated out (S36). More specifically, if it is judged that all of the n characters included in one phrase have been correctly inputted within a predetermined period of time (without undergoing the step S31), one point is added.

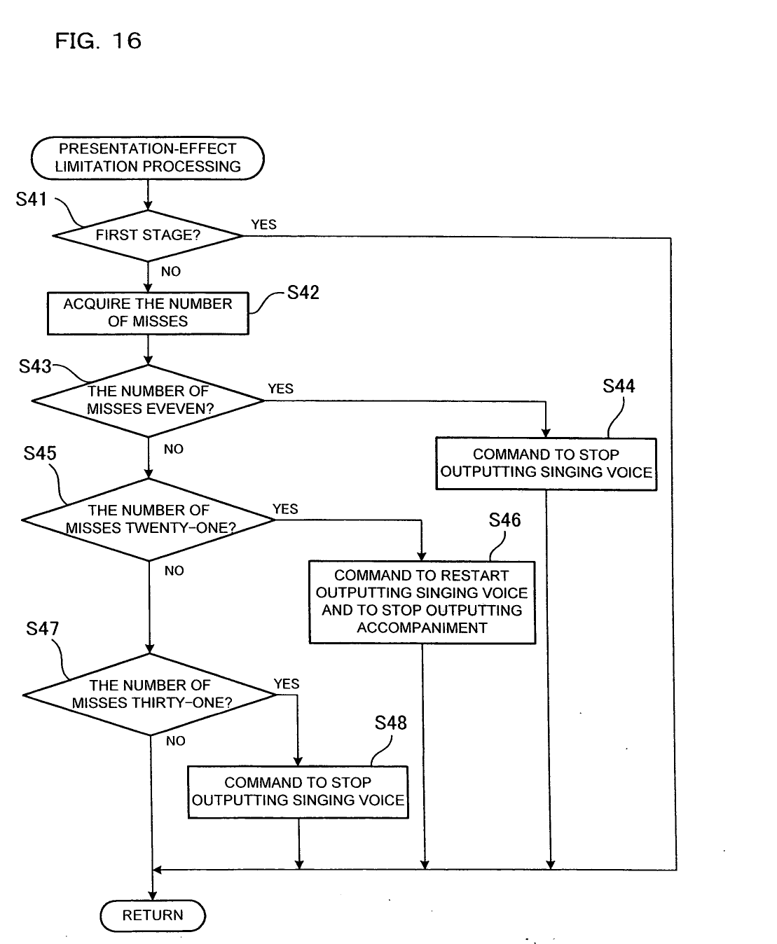

In S37, a presentation-effect limitation processing shown in FIG. 16 is executed based on the current number of mistypings and the current stage number, and also based on the determination table 45 (see FIG. 6) and the limit determination table 46 (see FIG. 7) stored in the ROM 53.

Then, judgment is made on whether inputs of all phrases included in the current stage have been judged or not. If it is judged that inputs of not all the phrases included in one stage have been judged (S38: NO), the processing returns to S24 in which the next phrase is acquired from RAM 54 and indicated by the lyrics indicator 22 of the main game screen 21 (S25).

If it is judged that inputs of all the phrases included in one stage have been judged (S38: YES), then a judgment is made on whether inputs of all stages have been judged or not (S39). If it is judged that inputs of all the stages have been judged (S39: YES), this typing-game execution processing ends irrespective of the points, and the processing proceeds to S7 of the main processing shown in FIG. 13.

If it is judged that inputs of not all the stages have been judged (S39: NO), then whether the number of mistypings is less than a predetermined value or not is judged (S40). If it is judged that the number of mistypings is less than the predetermined value (S40: YES), the processing returns to S24 in which a first phrase of the next stage is acquired from the RAM 54 and indicated by the lyrics indicator 22 of the main game screen 21 (S25). If it is judged that the number of mistypings is not less than the predetermined value (S40: NO), this typing-game execution processing ends, and the processing proceeds to S7 of the main processing shown in FIG. 13.

As a consequence, only when the total number of mistypings counted from the beginning of the game is less than the predetermined value, a player can proceed to the next stage. For example, the number of mistypings should be less than twenty in order to proceed from the first stage to the second stage, and should be less than thirty-five in order to proceed from the second stage to the third stage.

The presentation-effect limitation processing S37 will be described with reference to FIG. 16.

First, whether the song currently played is the first stage or not is judged (S41). If it is judged that the current song is the first stage (S41: YES), no limitation is put on presentation effects (see FIG. 6) and this presentation-effect limitation processing ends.

If it is judged that the current song is not the first stage (S41: NO), the number of mistypings which is stored in the RAM 42 is acquired (S42). This number of mistypings is increased when a character is not inputted within the predetermined period of time (S30, S31) and when it is judged that an incorrect character was inputted (S29) in the typing-game execution processing of FIG. 15.

In S43, whether the number of mistypings acquired in S42 is eleven or not is judged. If it is judged that the number of mistypings is eleven (S43: YES), the CPU 51 commands the sound control circuit 61 to stop outputting singing voice (S44).

If it is judged that the number of mistypings is not eleven (S43: NO), then whether the number of mistypings is twenty-one or not is judged (S45). If it is judged that the number of mistypings is twenty-one (S45: YES), the CPU 51 commands the sound control circuit 61 to restart outputting the singing voice and at the same time stop outputting the accompaniment (S46).

If it is judged that the number of mistypings is not twenty-one (S45: NO), then whether the number of mistypings is thirty-one or not is judged (S47). If it is judged that the number of mistypings is thirty-one (S47: YES), the CPU 51 commands the sound control circuit 61 to stop outputting the singing voice (S48). If it is judged that the number of mistypings is not thirty-one (S47: NO), this presentation-effect limitation processing ends.

Through the judgments and commands of S43 to S48, a sound output is limited in accordance with the limit determination table of FIG. 7. Thus, in the second and subsequent stages, if the number of mistypings is eleven to twenty, the output of singing voice is stopped and only accompaniment is outputted. If the number of mistypings is twenty-one to thirty, the output of accompaniment is stopped and only singing voice is outputted. If the number of mistypings is equal to or more than thirty-one, the sound output of accompaniment and the sound output of singing voice are both stopped.

In the typing-game machine 1 according to the first embodiment, as thus far described above, if a stage of the song currently played is the first stage, that is, if a first piece of the song is being played, a sound output is not limited irrespective of a game result, so that accompaniment and singing voice are outputted through the speakers 8, as shown in the determination table of FIG. 6. Therefore, at least in the first stage, every player can play a game with not-limited, complete sounds. This can suppress demotivating an inexperienced player or a player poor at typing, and at the same time can fully exhibit presentation effects using sounds. In the second and subsequent stages, on the other hand, one or both of an accompaniment output and a singing voice output is/are limited based on the number of mistypings made during a game (see FIG. 7 and S43 to S48 of FIG. 16). This offers a high game feeling because presentation effects change depending on a game result. Therefore, even if a player repeatedly plays games, he/she can keep enjoying the games without getting tired.

Since, in the second and subsequent stages, one or both of an accompaniment output and a singing voice output is/are stopped based on the number of mistypings made during a game, a high game feeling can be offered such as, depending on a game result, a shift to a new game condition where a part of presentation effects are not preformed. Thus, such a problem can be more effectively relieved as a player repeatedly playing games gets tired of a game.

Accompaniment and singing voice are outputted based on the song data stored in the song data storage area 56 (see FIG. 12) of the HDD 55. In association with outputting this song, a character string corresponding to the singing voice is shown on the main display 3. Typings are performed in accordance with this character string. This gives a game a sense of reality, thus improving a player's motivation for the game.

At least in the first stage, a song is played with not-limited, complete sounds. Therefore, presentation effects obtained from sounds, which means an effect of advertising the song, can fully be exhibited. This can improve a player's motivation to purchase a CD, a DVD, etc., of this song.

The typing-game machine 1 includes the main display 3 that displays game information which concerns a progress of a game, and the sub display 4 that displays effect image which is not directly involved in a progress of a game, e.g., the PV 20 and an advertisement. Accordingly, since during a game the main display 3 displays the main game screen 21 which concerns a progress of the game while the sub display 4 displays the PV 20 which concerns a song currently used in the game, a player can play the game with a sense of reality and therefore can further be motivated to play the game. In addition, since the two displays 3 and 4 display different screens, a variety of games can be offered as compared with in a single display mode. Further, if, in a single display mode, this single display displays not only the main game screen 21 but also the PV 20 which is not directly involved in a progress of a game, a player cannot easily see necessary information. In this embodiment, however, such a problem can be eliminated and a player can concentrate on playing a game.

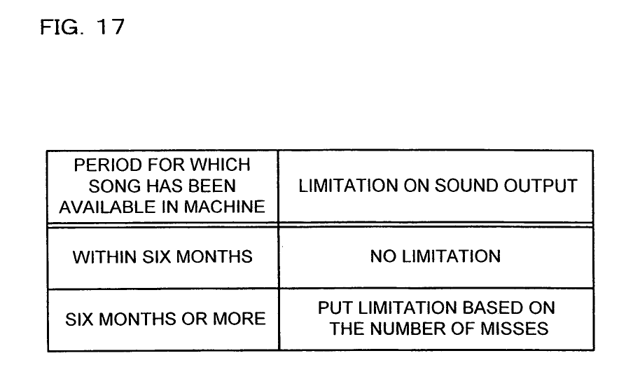

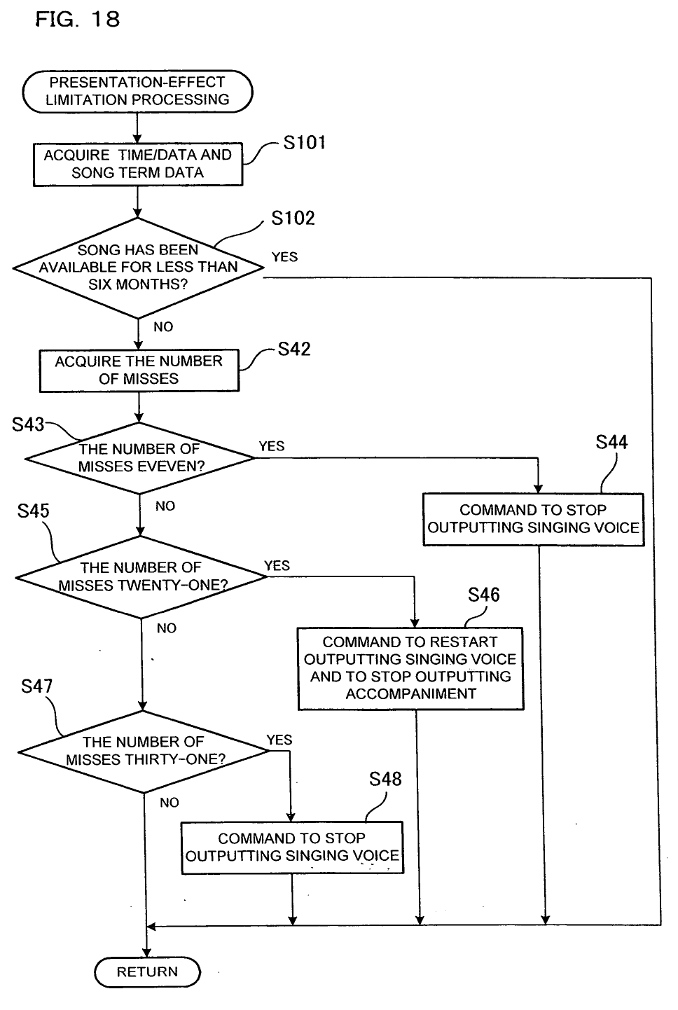

Next, a typing-game machine according to a second embodiment will be described with reference to FIGS. 17 and 18. In the following, the same members as those of the typing-game machine 1 of the first embodiment will be denoted by the common reference numerals, without a specific description thereof.

In the typing-game machine 1 of the first embodiment, in the second and subsequent stages of a song, a sound output is limited in accordance with the number of mistypings (see FIG. 6). In a typing-game machine of the second embodiment, however, if a song has been available in this machine for six months or more, a sound output is limited in accordance with the number of mistypings. The other constructions are identical to those of the first embodiment.

First, with reference to FIG. 17, a description will be given to a determination table 200 used in the second embodiment in order to determine whether a sound output should be limited or not.

The determination table 200 is used in order to determine whether outputting accompaniment and outputting singing voice should be limited or not during a game, based on a period for which a song used for a game has been available in the typing-game machine 1. Here, the period for which a song has been available means a period from a start date until now. The start date is a date on which the song was sent from the server 80 (see FIG. 10) and became available in this typing-game machine 1. If the period for which a song has been available is less than six months, a sound output is not limited and the speakers 8 output both accompaniment and singing voice. If the period for which a song has been available is not less than six months, a sound output is limited in accordance with the number of mistypings made.

The limit determination table 46 (see FIG. 7) of the first embodiment is also used in order to determine how a sound output should be limited in accordance with the number of mistypings in a case where the period for which a song has been available is not less than six months.

Next, with reference to FIG. 18, a description will be given to a presentation-effect limitation processing that is executed in the typing-game machine of the second embodiment. In the second embodiment, the same processings as described in the first embodiment (see FIGS. 13 to 15) are executed, but only a presentation-effect limitation processing S37 included in the typing-game execution processing (see FIG. 15) is different from that of the first embodiment. A program of the processing of FIGS. 18 is stored in the ROM 53 or RAM 54, and the CPU 51 executes this program.

First, current time/date data is acquired from the timer 58, and song term data is acquired from the term data storage area 56H (see FIG. 12) of the HDD 55 (S101). As described above, the term data include two data items, one about a start date of using song data and one about an end date of using song data.

Next, based on the data thus acquired in S101, whether a period for which a song selected in the song selection processing S5 included in the main processing (see FIG. 13) has been available is less than six months or not is judged (S102). If it is judged that the period is less than six month (S102: YES), no limitation is put on presentation effects (see FIG. 17) and this presentation-effect limitation processing ends.

If it is judged that the period is not less than six month (S102: NO), the number of mistypings made which is stored in the RAM 42 is acquired (S42). After S42, the processing undergoes the same steps as those of the presentation-effect limitation processing of the first embodiment (see FIG. 16).

In the typing-game machine according to the second embodiment, as thus far described above, if a period for which a song used for a game has been available is less than six months, a sound output is not limited irrespective of a game result, so that accompaniment and singing voice are outputted through the speakers 8, as shown in the determination table of FIG. 17. Therefore, the same effects as in the first embodiment can be obtained.

That is, at least when a song which has been available in the machine 1 for less than six months is selected, every player can hear the song with not-limited, complete sounds while playing a game. This can suppress demotivating an inexperienced player or a player poor at typing. At the same time, presentation effects obtained from sounds, which means an effect of advertising the song, can fully be exhibited, so that a player's motivation to purchase a CD, a DVD, etc., of this song can be improved. When, on the other hand, a song which has been available in the machine 1 for six months or more is selected, one or both of an accompaniment output and a singing voice output is/are limited based on the number of mistypings made during a game. This offers a high game feeling because presentation effects change depending on a game result. Therefore, even if a player repeatedly plays games, he/she can keep enjoying the games without getting tired.

In the above-described- embodiments, the presentation-effect limitation processing is for stopping sounds which are outputted through the speakers 8. However, this is not limitative. For example, it may also be possible that a display mode of the PV 20 which is displayed on the sub display 4 during a game is changed in accordance with the number of mistypings, among “a full-screen display mode”, “a four-split display mode”, “an eight-split display mode” and “a non-display mode”. Alternatively, it may also be possible that the number of external lights 7 lighting during a game is changed among “eight”, “four”, and “zero”. Alternatively, it may also be possible that which key(s) of the keyboard 6 emit(s) a light by means of the full-color LED(s) 155 disposed inside the key(s) (see FIG. 9) is changed among “all the keys”, “only character input keys 111”, and “none”. A display area of the main game screen 21 on the main display 3 may be reduced in accordance with the number of mistypings made.

In the typing-game machine 1 according to the above embodiments, a mode of presentation effects is changed in accordance with the number of mistypings, as shown in FIGS. 7, 16, and 18. However, this is not limitative. For example, the mode of presentation effects may be changed in accordance with a ratio of the number of mistypings to the total number of stages played or in accordance with points each of which is counted when an input of one phrase is completed without a mistyping.

In the first embodiment, only if a stage of the song currently played is the first stage, presentation effects are not limited irrespective of the number of mistypings. However, it may also be possible that presentation effects are not limited irrespective of the number of mistypings only if the song currently played is in stages other than the first stage, e.g., in the second stage. Alternatively, it may also be possible that limitation of presentation effects in the second stage is affected by the number of mistypings made in the first stage. For example, presentation effects in the first stage is controlled, and, if the number of mistypings made in the first stage is less than a predetermined value, no limitation is put on presentation effect in the second stage

The song title indicator 16 may indicate not only a song title but also an image of a singer or a PV.

The song selection screen 15 and the game result screen 30 may be displayed on the sub display 4 instead of the main display 3.

In the above embodiment, the main display 3 displays information necessary for progressing a game such as the main game screen 21, while the sub display 4 displays an effect image which is not directly involved in a progress of a game such as the PV 20 of a song. However, it may also be possible that the main display 3 displays an effect image and the sub display 4 displays information necessary for progressing a game. Alternatively, any one of the main display 3 and the sub display 4 may be omitted to adopt only a single display.

The typing-game machine 1 according to the above embodiments is connected to the server 80, and song data stored in the HDD 55 (see FIG. 11) can be updated by downloading data from the server 80. However, this is not limitative. The typing-game machine 80 may not be connected to the server 80, and song data stored in the HDD may be non-updatable. In addition, it may also be possible to update song data independently of the server 80.

Illustrated in the above embodiments is a cabinet-type one which is placed in a game arcade or the like. However, this is not limitative. The present invention is applicable to a typing-game machine that offers a game playable on an individual PC by installing in the PC a software program purchased by a player. The present invention is also applicable to a home-use game machine into which a typing game is introduced via a medium such as a cartridge, a CD-ROM, and the like. The typing game may be installed in the home-use game machine beforehand.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A typing-game machine comprising:
a display unit that displays a character string for a game;
a sound output unit that outputs a sound for a game;
an input unit that has a plurality of keys respectively associated with a plurality of characters;
a judgment unit that judges whether a character string inputted through the input unit agrees with a character string displayed through the display unit or not;
a game control unit that control a game; and
a presentation-effect limitation unit that at least partly limits, based on a judgment result made by the judgment unit, at least one of a display made through the display unit and an output made through the sound output unit, wherein:
the game control unit controls a game based on either one of a first game mode in which the presentation-effect limitation unit does not work and a second game mode in which the presentation-effect limitation unit works; and
for a predetermined period of time after a start of a game, the game is controlled based on the first game mode irrespective of the judgment result.

2. The typing-game machine according to claim 1, wherein the presentation-effect limitation unit at least partly stops at least one of a display made through the display unit and an output made through the sound output unit.

3. The typing-game machine according to claim 1, further comprising a storage unit that stores song data, wherein:
a sound outputted through the sound output unit is accompaniment and singing voice that are preformed based on the song data stored in the storage unit; and
a character string displayed through the display unit corresponds to the singing voice outputted through the sound output unit.

4. The typing-game machine according to claim 3, wherein the presentation-effect limitation unit stops, based on a judgment result made by the judgment unit, at least one of an output of the accompaniment and an output of the singing voice made through the sound output unit.

5. The typing-game machine according to claim 1, wherein the display unit includes a first display that displays game information which concerns a progress of a game such as the character string, and a second display that displays an effect image which is not directly involved in a progress of a game.

6. A game system comprising the typing-game machine according to claim 1 and a server communicatably connected in communication with the typing-game machine,
wherein the typing-game machine is capable of updating game data used therein by downloading data from the server.
